(19) United States
(12) Patent Application Publication
(10) Pub. No.: US 2004/0187015 A1
(43) Pub. Date: Sep. 23, 2004

(54) Generating numbers for use in product identifications

(76) Inventors: Kenneth J. Geer, Auburn, CA (US); Thibaut Hourteillan, Roseville, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/394,100

(22) Filed: Mar. 21, 2003

(51) Int. Cl. H04L 9/00

(52) U.S. Cl. 713/200

(57) ABSTRACT

Techniques are disclosed for generating identification numbers for use in identifying products such as servers. A number identifying a server includes a first field that stores a timestamp, a second field that stores a random number, and a third field that stores an error correction code being generated from the timestamp and the random number. The timestamp, identified as a first timestamp, is derived from a second timestamp having bits representing accuracy better than that of the first timestamp. The random number, e.g., the first random number, is created from a second random number combined with other data. The error correction code helps verify whether an identification number is what it is supposed to be.

### INCORPORATION BY REFERENCE

This application incorporates by reference the document “Wired for Management Baseline,” version 2.0, released Dec. 18, 1998 by Intel Corporation of Santa Clara, Calif.

### FIELD OF THE INVENTION

The present invention relates generally to product identifications and, more specifically, to generating numbers for use in such identifications.

### BACKGROUND OF THE INVENTION

Numbers have been used widely as identifications for products including servers, computers, printers, etc. Generally, the identification, thus the number, is unique, i.e., a first number identifying a first server is different from a second number identifying a second server. As the total number of produced servers increases, the number of digits or bits representing the number used to identify those servers increases. Handling a large number of digits for a large number of servers poses several challenges. For example, entering an identification number into a computer and/or marking the number on the server is prone to errors because during the process the person entering the data may mistype the number. Once a number having a lot of digits is created, determining whether the number has been corrupted and/or altered is important and can be quite difficult. When a server is tied to a licensing scheme, changing the number identifying the server may change the license terms and/or conditions. Determining whether the identification number is genuine or falsely created is also important and difficult.

The Universally Unique IDentifier (UUID) standard specified in “Wired for Management Baseline,” released Dec. 18, 1998 by Intel Corporation of Santa Clara, Calif. defines a format that many company use to generate identification numbers for their servers. However, the UUID format does not provide for any error detection in such format, and many approaches thus add extra numbers to the identification number to add the error detection data. Unfortunately, adding such numbers is no longer compliant with the UUID format.

Based on the foregoing, it is desirable that mechanisms be provided to solve the above deficiencies and related problems.

### SUMMARY OF THE INVENTION

The present invention provides techniques for generating identification numbers for use in identifying products. In an embodiment, the products are servers, and a number identifying a server includes a first field that stores a timestamp, a second field that stores a random number, and a third field that stores an error correction code being generated from the timestamp and the random number. The timestamp, identified as a first timestamp, is derived from a second timestamp having bits representing accuracy better than the first timestamp. For example, the second timestamp includes bits representing milliseconds and microseconds while the first timestamp does not include those bits. As a result, the first timestamp has accuracy less than that of the second timestamp. The random number, e.g., the first random number, is created from a second random number combined with other data. The error correction code helps verify whether an identification number is what it is supposed to be.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 shows an identification number, in accordance with an embodiment;

FIG. 2 shows a timestamp in accordance with an embodiment;

FIG. 3 shows a flowchart illustrating steps in generating an identification number, in accordance with an embodiment;

FIG. 4 shows a flowchart illustrating steps in generating a temporary UUID, in accordance with an embodiment; and

FIG. 5 shows a computer system upon which embodiments of the invention may be implemented.

### DETAILED DESCRIPTION OF THE PREFERRED EMBODIMENT

In the following description, for the purposes of explanation, numerous specific details are set forth in order to provide a thorough understanding of the present invention. However, it will be apparent to one skilled in the art that the invention may be practiced without these specific details. In other instances, well-known structures and devices are shown in block diagram form in order to avoid obscuring the invention.

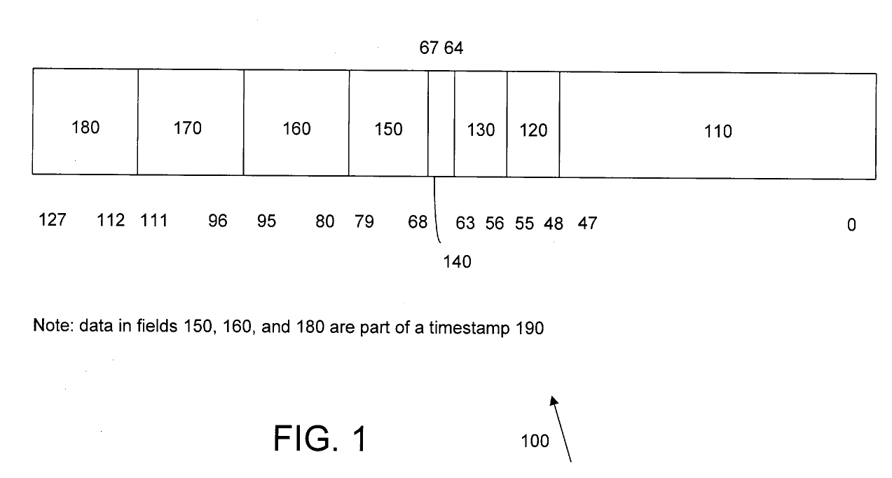

FIG. 1 shows a number 100 in accordance with an embodiment that complies with the Universally Unique IDentifier (UUID) standard specified in “Wired for Management Baseline,” released Dec. 18, 1998 by Intel Corporation of Santa Clara, Calif. An UUID is also known as a GUID (Globally Unique Identifier) and is guaranteed to be different or extremely likely to be different from all other UUIDs/GGIDs generated until 3400 A.D.

Number 100 includes 128 bits from 0-127 and seven fields 110, 120, 130, 140, 150, 160, 170, and 180 having 48 bits, 8 bits, 8 bits, 4 bits, 12 bits, 16 bits, 16 bits, and 16 bits, respectively. Field 110 stores a random number R when bit 47 is set to a one or stores an IEEE address if bit 47 is set to a zero. Field 120 stores the low field of the clock sequence specified in the UUID format. Field 130 stores the high field of the clock sequence multiplexed with a variant. Field 140 stores the version of the UUID format. Field 150 stores the high field of a timestamp, e.g., timestamp 190 (not shown), that includes dates, months, and years. Field 160 stores the middle field of timestamp 190 that includes minutes and hours, and field 180 stores the low field of timestamp 190 that includes seconds. Field 170 stores an error correction code CRC. The clock sequence, the variant, and the version of the UUID format in field 120, 130, and 140 are defined in the above-mentioned documents Wired for Management Baseline. However, the invention is not limited to such data in their corresponding fields, and is not limited to the number of fields and/or the number of bits in a field.

### The Timestamp

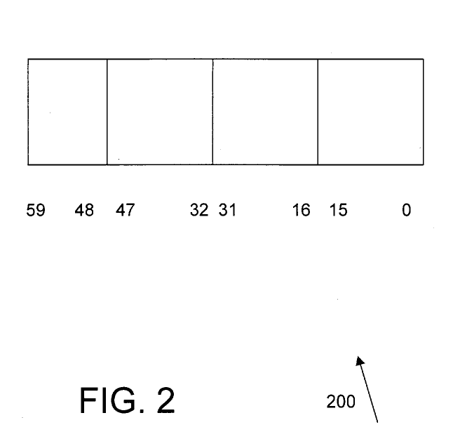

Fields 180, 160, and 150, store different parts of timestamp 190, e.g., a first timestamp, which is derived from a second timestamp, e.g., timestamp 200 as shown in FIG. 2, in accordance with an embodiment. Timestamp 200 includes 60 bits in which bit 0 is the least significant bit and bit 59 is the most significant bit. Bits 0-15 store data for microseconds and milliseconds while bits 16-31 store data for seconds of timestamp 200. Similarly, bits 32-59 store data for minutes, hours, days, and years of timestamp 200.

Lower-significant bits of timestamp 200 are not used for timestamp 190, and the number of bits that are not used varies, depending on the desired accuracy. For example, in an embodiment, identification numbers 100 are generated at least one second apart, and timestamp 190 therefore does not include bits representing data smaller than seconds. As a result, bits 0-15 of timestamp 200 that represent microseconds and milliseconds are not used in timestamp 190, and thus are not included in identification number 100 in FIG. 1. Those skilled in the art will recognize that because timestamp 190 does not have bits representing milliseconds and microseconds as timestamp 200 does, time stamp 190 has accuracy less than that of timestamp 200. Bits 16-31, 32-47, and 48-59 of timestamp 200 correspond to bits 112-127, 80-95, and 68-79 of number 100, respectively.

Timestamp 200 is calculated based on a reference that at 00:00:00.00 on Oct. 15, 1852, all bits 0-59 of timestamp 200 are zeros. Based on this reference, timestamp 200 increases as time elapses. For example, when timestamp 200 increases to a binary 01, 100 nanoseconds have elapsed from 00:00 of Oct. 15, 1852. Similarly, when timestamp 200 increases to a binary 010, 200 nanoseconds have elapsed from 00:00 AM of Oct. 15, 1582, etc.

Depending on the various systems, a system call such as “gettime( )” provides timestamp 200. Further, timestamp 200 may reference a date different from Oct. 15, 1582, such as Nov. 1, 1970, for Unix systems. That is, under these Unix systems, at time 00:00 on Nov. 1, 1970, all bits of timestamp 200 are zeros, and a gettime( ) routine provides a timestamp calculated based on this reference. The present invention is not limited to a reference date of timestamp 200.

### The Cyclic Redundancy Check (CRC)

Cyclic Redundancy Check (CRC) is a technique that protects blocks of data to obtain data reliability. Embodiments of the inventions use this technique to generate a 16-bit CRC number for use in error correction code field 170. However, depending on implementations, the number of bits in field 170 varies, and embodiments of the invention use the CRC algorithm to produce numbers having the same size, e.g., same number of bits, as field 170. Further, embodiments of the invention may use different techniques or algorithms including various embodiments of the CRC algorithm and other cyclic code, BCH codes, etc. Data in fields 180, 160, 150, 140, 130, 120, and 110 that include timestamp 190 and random number R are inputs for calculating that 16-bit CRC number. In general, generating a CRC number based on a message M comprises the steps of 1) Choosing a width W and a polynomial G of width W, 2) Appending W zero bits to the message M, resulting in a message M′ 3) Dividing message M′ by polynomial G using CRC arithmetic, and the remainder of the division is the checksum or the 16-bit CRC number. For example, using a message M, in hex, of c4350000-3ad4-1025-b6e3-a2ff1428934e2 with a width W of 16, and a polynomial G of width 16 as (16, 15, 2, 0) results in a message M′ of c4350000-3ad4-1025-b6e3-a2ff1428934e2-0000, and the checksum or CRC number of a3fa. Using the CRC-16 in conjunction with techniques of the invention is effective for detecting single bit errors, double bit errors, odd number of bit errors, and burst errors, etc.

### Other Algorithms

Algorithms that result in a number or an “error protection code” having the same width of field 170 are within the scope of embodiments of the invention. Examples of these algorithms include summation, weighted summation, parity check, their variations and equivalence. As the width of field 170 varies, which depends on implementations, the width of the error protection codes varies accordingly. In the embodiment of FIG. 1, field 170 has 16 bits, and, a 16-bit number is therefore used as an example. Consequently, in the summation algorithm, because field 170 has 16 bits, the field check is selected to also have 16 bits. As a result, in a “byte” summation, every byte of number 100 is summed, and the result or the summation is modulo 2 to the power of the width of the field check, which is modulo 2\hat{ }16 or 65536. Similarly, in a “bit” algorithm, every bit of number 100 is summed, and the result is modulo 2\hat{ }16. However, embodiments of the invention are not limited to “bit” or “byte” algorithms, variations including various numbers of bits, bytes, or groups of bits and/or bytes of number 100 that are used in the summation are within the scope of embodiments of the invention.

In a weighted summation, every bit, byte, or group of bits and/or bytes that is used in the summation is given a weight coefficient. The bit, byte, or group is then multiplied by its corresponding weight coefficient before the summation and modulo.

In a parity check, the size of the field check is 1, and the summation is thus modulo 2\hat{ }1 or 2. In a partial parity check, number 100 is divided into n subsets, e.g., S(1) to S(n). The parity check algorithm is then applied to each subset S, resulting in n parity bits P, which are concatenated to form the protection code. The width of each subset S may or may not have the same size. However, for illustration purposes, number 100 having 128 bits is divided into sixteen subsets S(1) to S(16) of equal width. Applying the parity bit algorithm to sixteen subsets S(1) to S(16) results in sixteen parity bits P(1) to P(16), which are concatenated to form a sixteen-bit error protection code to be used in field 170.

### Steps in Generating Identification Numbers

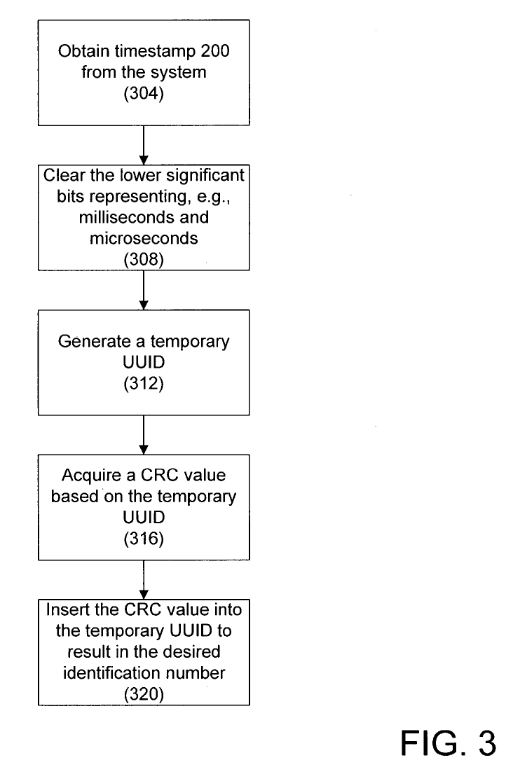

FIG. 3 is a flowchart illustrating the steps in generating an identification number, e.g., number c4353afa-3ad4-1025-b6e3-a2ff1428934e2, in accordance with an embodiment.

In step 304, timestamp 200 represented by 025-3ad4-c435b89a is obtained from a computer system generating the corresponding identification number.

In step 308, data in lower bits of timestamp 200 are cleared, e.g., the data b89a in bits 0-15 are zeroed.

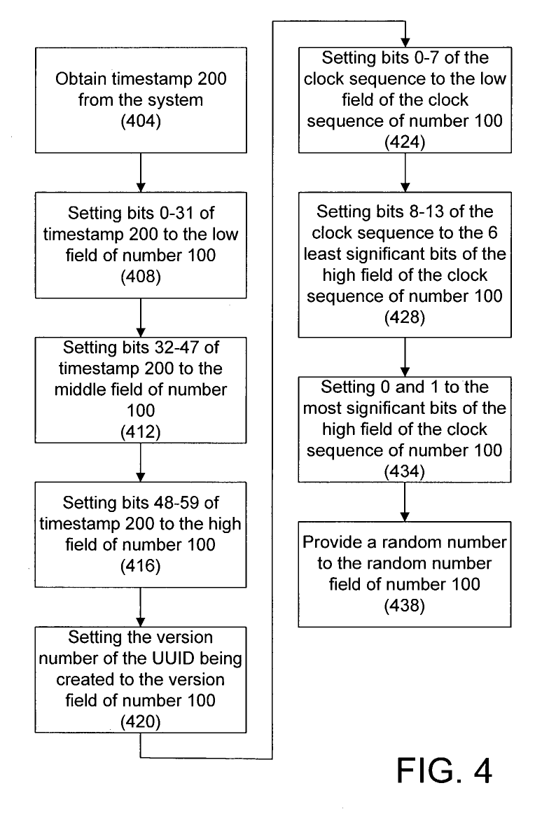

In step 312, based on the Wired for Management Baseline specification, a temporary UUID c4350000-3ad4-1025-b6e3-a2ff1428934e2 is created in accordance with the algorithm in the below FIG. 4.

In step 316, a CRC algorithm is performed on the temporary UUID value c43500-3ad4-1025-b6e3-a2ff1428934e2, and results in an error correction value a3fa.

In step 320, the error correction value a3fa is inserted into the temporary UUID c4350000-3ad4-1025-b6e3-a2ff1428934e2 to obtain the final UUID c435a3fa-3ad4-1025-b6e3-a2ff1428934e2.

### Steps in Generating a Temporary UUID

FIG. 4 shows a flowchart illustrating steps in generating temporary UUID c4350000-3ad4-1025-b6e3-a2ff1428934e2 in step 312, in accordance with an embodiment.

In step 404, the values for timestamp 200, e.g., 025-3ad4-c435b89a, and the clock sequence are obtained. For this purpose, timestamp 200 and the clock sequence are considered a 60-bit and a 14-bit unsigned integer, respectively.

In step 408, the time-low field 180 is set to bits 0-31 of time stamp 200 in the same order of significance. Field 180 is thus set to c435b89a.

In step 412, the time-mid field, e.g., field 160, is set to bit 32-47 of timestamp 200, or to 3ad4, in the same order of significance.

In step 416, the time-high field 150 is set to bits 48-59 of timestamp 200, e.g., to 025, in the same order of significance.

In step 420, the version field 140 is set to the 4-bit version number corresponding to the UUID version being created.

In step 424, the low-field 120 of clock sequence is set to bits 0-7 of the clock sequence in the same order of significance. The UUID specifies that the clock sequence field is initialized to a random number and this number is incremented by one each time a UUID number is generated. In an embodiment, a random number is used each time.

In step 428, the 6 least significant bits of the high-field 130, is set to the most significant bits (bits 8-13) of the clock sequence in the same order of significance.

In step 434, the two most significant bits of field 130 are set to 0 and 1, respectively.

In step 438, field 110 is set to the 48-bit IEEE address in the same order of significance when the multicast bit or bit 47 of field 110 is set to a 0. Alternatively field 110 is set to a random number when this multicast bit is set to a 1.

Generally, a number represented by 48 bits is quite large, and using those 48 bits to generate a random number R in field 110 can hardly generate the same number twice. Because random number R is random, number R combined with data in other fields such as 120, 130, 140, etc., results in a different random number, e.g., random number R′. Consequently, number 100 may be considered as having three fields in which the first field comprises three fields 180, 160, and 150, and stores timestamp 190. The second field comprises field 170 and stores the error correction code, and the third field comprises fields 110, 120, 130, and 140 and stores random number R′. Different fields storing different data are within the scope of embodiments of the invention.

Various embodiments of the invention generate a number 100 at least one second apart. As a result, as each second elapses, timestamp 190 increases and therefore is unique. Consequently, numbers 100 that are generated using timestamp 190 combined with random number R or number R′ are unique.

In an embodiment, having the CRC number as part of an identification number 100 helps verify correctness of that identification number. For example, in the above example, when a number N, e.g., c4353afa-3ad4-1025-b6e3-a2ff1428934e2, has been generated and is ready to be marked on a server, the CRC number 3afa in field 170 is zeroed to result in number N′. A CRC algorithm is then performed on this number N′. If number N′ is number N having zeros in field 170, then generating the CRC number should yield the number 3afa. However, if a different CRC number is yielded, then number N's is not number N having zeros in field 170 and/or the CRC number 3afa entered into number N is incorrect.

### Computer System Overview

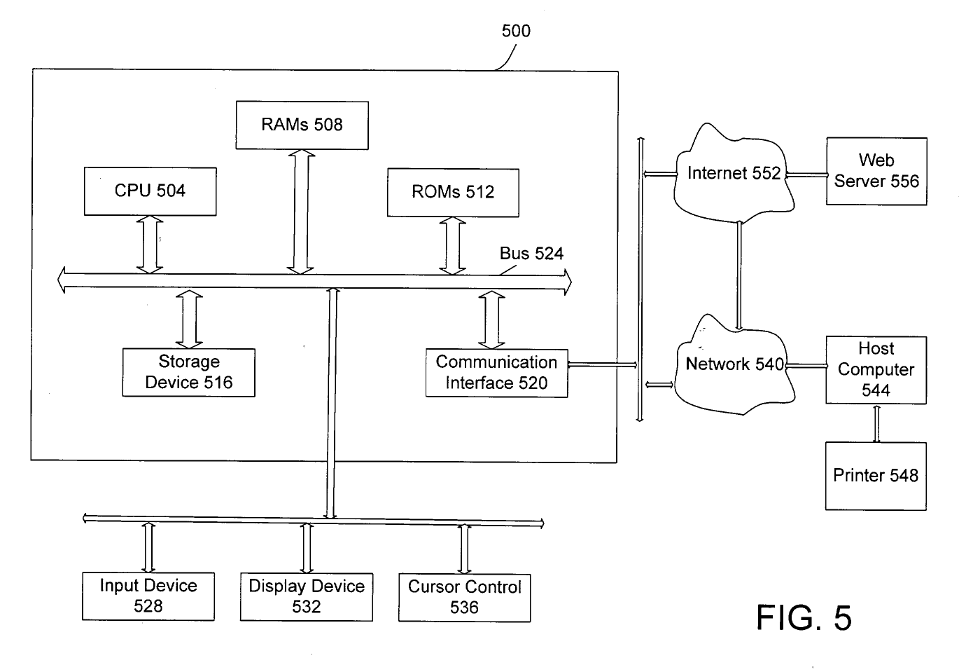

FIG. 5 is a block diagram showing a computer system 500 upon which an embodiment of the invention may be implemented. For example, computer system 500 may be implemented to perform functions in accordance with the techniques described above, e.g., to acquire a timestamp, to generate an UUID, etc. In an embodiment, computer system 500 includes a central processing unit (CPU) 504, random access memories (RAMs) 508, read-only memories (ROMs) 512, a storage device 516, and a communication interface 520, all of which are connected to a bus 524.

CPU 504 controls logic, processes information, and coordinates activities within computer system 500. In an embodiment, CPU 504 executes instructions stored in RAMs 508 and ROMs 512, by, for example, coordinating the movement of data from input device 528 to display device 532. CPU 504 may include one or a plurality of processors.

RAMs 508, usually being referred to as main memory, temporarily store information and instructions to be executed by CPU 504. Information in RAMs 508 may be obtained from input device 528 or generated by CPU 504 as part of the algorithmic processes required by the instructions that are executed by CPU 504.

ROMs 512 store information and instructions that, once written in a ROM chip, are read-only and are not modified or removed. In an embodiment, ROMs 512 store commands for configurations and initial operations of computer system 500.

Storage device 516, such as floppy disks, disk drives, or tape drives, durably stores information for use by computer system 500.

Communication interface 520 enables computer system 500 to interface with other computers or devices. Communication interface 520 may be, for example, a modem, an integrated services digital network (ISDN) card, a local area network (LAN) port, etc. Those skilled in the art will recognize that modems or ISDN cards provide data communications via telephone lines while a LAN port provides data communications via a LAN. Communication interface 520 may also allow wireless communications.

Bus 524 can be any communication mechanism for communicating information for use by computer system 500. In the example of FIG. 5, bus 524 is a media for transferring data between CPU 504, RAMs 508, ROMs 512, storage device 516, communication interface 520, etc.

Computer system 500 is typically coupled to an input device 528, a display device 532, and a cursor control 536. Input device 528, such as a keyboard including alphanumeric and other keys, communicates information and commands to CPU 504. Display device 532, such as a cathode ray tube (CRT), displays information to users of computer system 500. Cursor control 536, such as a mouse, a trackball, or cursor direction keys, communicates direction information and commands to CPU 504 and controls cursor movement on display device 532.

Computer system 500 may communicate with other computers or devices through one or more networks. For example, computer system 500, using communication interface 520, communicates through a network 540 to another computer 544 connected to a printer 548, or through the world wide web 552 to a server 556. The world wide web 552 is commonly referred to as the “Internet.” Alternatively, computer system 500 may access the Internet 552 via network 540.

Computer system 500 may be used to implement the techniques described above. In various embodiments, CPU 504 performs the steps of the techniques by executing instructions brought to RAMs 508. In alternative embodiments, hard-wired circuitry may be used in place of or in combination with software instructions to implement the described techniques. Consequently, embodiments of the invention are not limited to any one or a combination of software, firmware, hardware, or circuitry.

Instructions executed by CPU 504 may be stored in and/or carried through one or more computer-readable media, which refer to any medium from which a computer reads information. Computer-readable media may be, for example, a floppy disk, a hard disk, a zip-drive cartridge, a magnetic tape, or any other magnetic medium, a CD-ROM, a CD-RAM, a DVD-ROM, a DVD-RAM, or any other optical medium, paper-tape, punch-cards, or any other physical medium having patterns of holes, a RAM, a ROM, an EPROM, or any other memory chip or cartridge. Computer-readable media may also be coaxial cables, copper wire, fiber optics, acoustic or electromagnetic waves, capacitive or inductive coupling, etc. As an example, the instructions to be executed by CPU 504 are in the form of one or more software programs and are initially stored in a CD-ROM being interfaced with computer system 500 via bus 524. Computer system 500 loads these instructions in RAMs 508, executes some instructions, and sends some instructions via communication interface 520, a modem, and a telephone line to a network, e.g. network 540, the Internet 552, etc. A remote computer, receiving data through a network cable, executes the received instructions and sends the data to computer system 500 to be stored in storage device 516.

In the foregoing specification, the invention has been described with reference to specific embodiments thereof. However, it will be evident that various modifications and changes may be made thereto without departing from the broader spirit and scope of the invention. Accordingly, the specification and drawings are to be regarded as illustrative rather than as restrictive.

What is claimed is:

1. A method for generating an identification number for use in identifying a product, comprising the steps of:
using a first field of the identification number to store a first timestamp;
using a second field of the identification number to store a first number; and
using the first timestamp and the first number as inputs to generate a second number; and
using a third field of the identification number to store the second number.

2. The method of claim 1 wherein the first field comprises a plurality of fields storing various parts of the first timestamp.

3. The method of claim 1 wherein the second field comprises a plurality of fields storing various parts of the first number.

4. The method of claim 1 wherein the first number is generated in one or a combination of randomly generated and uniquely generated.

5. The method of claim 1 wherein the first timestamp is derived from a second timestamp having accuracy better than that of the first timestamp.

6. The method of claim 1 wherein generating the second number uses a cyclic redundancy check algorithm.

7. The method of claim 1 wherein generating the second number uses one or a combination of the following algorithms: summation, weighted summation, parity check, partial parity check, cyclic code, and BCH code.

8. The method of claim 1 wherein the identification number is compliant with the Universal Unique Identifier format.

9. A method for generating an identification number, comprising the steps of:
using a first field to store a random number;
using a second field to store a low field of a clock sequence;
using a third field to store a high field of the clock sequence multiplexed with a variant;
using a fourth field to store a version of the identification number;
using a fifth field to store a high field of the first timestamp;
using a sixth field to store a middle field of the first timestamp;
using a seventh field to store an error correction code generated from the cyclic redundancy check algorithm; and
using an eight field to store a low field of the first timestamp.

10. The method of claim 9 wherein the error correction code is replaced with a number generated from one or a combination of:
summation algorithm;
weighted summation algorithm;
parity check algorithm;
partial parity check algorithm; and
BCH code algorithm.

11. A computer-readable medium embodying instructions to perform a method for generating an identification number for use in identifying a product, the method comprising the steps of:
using a first field of the identification number to store a first timestamp;
using a second field of the identification number to store a first number; and
using the first timestamp and the first number as inputs to generate a second number; and
using a third field of the identification number to store the second number.

12. The computer-readable medium of claim 11 wherein the first field comprises a plurality of fields storing various parts of the first timestamp.

13. The computer-readable medium of claim 11 wherein the second field comprises a plurality of fields storing various parts of the first number.

14. The computer-readable medium of claim 11 wherein the first number is generated in one or a combination of randomly generated and uniquely generated.

15. The computer-readable medium of claim 11 wherein the first timestamp is derived from a second timestamp having accuracy better than that of the first timestamp.

16. The computer-readable medium of claim 11 wherein generating the second number uses a cyclic redundancy check algorithm.

16. The computer-readable medium of claim 11 wherein generating the second number uses a cyclic redundancy check algorithm.

17. The computer-readable medium of claim 11 wherein generating the second number uses one or a combination of the following algorithms: summation, weighted summation, parity check, partial parity check, cyclic code, and BCH code.

18. The computer-readable medium of claim 1 wherein the identification number is compliant with the Universal Unique Identifier format.

19. A computer-readable medium embodying instructions to perform a method for generating an identification number, the method comprising the steps of:
using a first field to store a random number;
using a second field to store a low field of a clock sequence;
using a third field to store a high field of the clock sequence multiplexed with a variant;
using a fourth field to store a version of the identification number;
using a fifth field to store a high field of the first timestamp;
using a sixth field to store a middle field of the first timestamp;
using a seventh field to store an error correction code generated from the cyclic redundancy check algorithm; and
using an eight field to store a low field of the first timestamp.

20. The computer-readable medium of claim 19 wherein the error correction code is replaced with a number generated from one or a combination of:
summation algorithm;
weighted summation algorithm;
parity check algorithm;
partial parity check algorithm; and
BCH code algorithm.
